(19) United States
(12) Patent Application Publication
(10) Pub. No.: US 2026/0222203 A1
(43) Pub. Date: Jul. 30, 2026

(54) PUBLIC ELECTRONIC COMMUNICATION VERIFICATION UTILIZING AUTHENTICITY SCORE

(71) Applicant: Bank of America Corporation, Charlotte, NC (US)

(72) Inventors: Vinesh Patel, Greenwich (GB); Maharaj Mukherjee, Poughkeepsie, NY (US); Michael Young, Davidson, NC (US)

(21) Appl. No.: 19/037,585

(22) Filed: Jan. 27, 2025

(51) Int. Cl. H04L 9/32

(52) U.S. Cl. CPC H04L 9/321

(57) ABSTRACT

Arrangements are provided for detecting altered and false digital communications by maintaining authentic publicly disseminated digital communications securely in a publicly available repository. Subsequent unverified digital communications are analyzed to determine an authenticity score indicating how likely the unverified digital communication accurately conveys the same information as in the stored authentic digital communication. The authenticity score is used to quickly verify whether unverified digital communications are genuine and unaltered versions of the authentic digital communications or whether they include misinformation or disinformation.

### BACKGROUND

Misinformation and disinformation are present problems due to the rapid dissemination of news and information over electronic media, such as the Internet, and the emergent capability of generative artificial intelligence (AI) to manipulate text and multimedia. Publicly available AI allows anyone to alter news stories, corporate press releases, photos, multimedia, etc., to generate convincing fake and misleading information. Online social platforms allow the modified material to spread quickly and often be amplified due to algorithms that push information to users based on user biases and viewing history. At the same time, the ability of users to verify the information they receive is often limited or nonexistent, which leads to a lack of trust in the information and an inability to rely on the information in practical ways, such as making economic or investment decisions or using the information in scientific analysis.

### SUMMARY

The following summary is intended to provide a simplified understanding of some aspects of the disclosure. It is not a comprehensive overview, nor does it aim to identify key elements or delineate the scope of the disclosure. Instead, it serves as a brief introduction to the concepts discussed in the subsequent description.

Aspects of the disclosure provide effective, efficient, scalable, and convenient technical solutions that address and overcome the technical issues associated with determining the authenticity of digital communications.

In some aspects, a computing platform may access a plurality of authenticated digital communications hosted on one or more servers and publicly accessible via an Internet, receive, via a communication interface, an authentication request including an unverified digital communication, and generate an authenticity score for the unverified digital communication. The authenticity score indicates a degree of accuracy of information conveyed in the unverified digital communication relative to information conveyed in at least one of the plurality of authenticated digital communications. The computing platform may then transmit, via the communication interface and in response to the authentication request, an authentication response that includes the authenticity score. The plurality of authenticated digital communications maintained on the one or more servers may be encoded in a plurality of tamper-proof distributed ledgers. The unverified digital communication and each of the plurality of authenticated digital communications may include text data, audio data or video data received via the Internet.

In some aspects, the computing platform may identify, in the authentication response, one of the plurality of authenticated digital communications to which the unverified digital communication is most similar.

A computing platform may further receive the plurality of authenticated digital communications via transmission over one or more public electronic mediums and encode the plurality of authenticated digital communications into the plurality of tamper-proof distributed ledgers, respectively. For each authenticated digital communication of the plurality of authenticated digital communications, the computing platform may generate quantum-resistant hashes, respectively, from consecutive intervals of the authenticated digital communication and include the consecutive intervals of the authenticated digital communication and the quantum-resistant hashes into one of the plurality of tamper-proof distributed ledgers.

In some examples, the computing platform may receive, in the authentication request, an identification of one of the plurality of authenticated digital communications, and generate the authenticity score using the one of the plurality of authenticated digital communications as a benchmark for the authenticity score.

The computing platform may generate the authenticity score further based on one or more of: the authentication request being received from a trusted network domain, the authentication request being received from a domain having a registrant being identified in a trusted party list, and the unverified digital communication being accessible via a uniform resource locator (URL) identified in an enterprise APL approved list.

Various examples may include the computer platform using one or more large language models to evaluate an amount of correspondence between the information conveyed in the unverified digital communication to the information conveyed in the at least one of the plurality of authenticated digital communications, wherein the degree of accuracy is based on the amount of correspondence.

In some aspects, the computing platform may perform sentiment analysis of the unverified digital communication and the at least one of the plurality of authenticated digital communications, wherein the degree of accuracy is based on the sentiment analysis. The sentiment analysis may be based on natural language processing, voice processing, or image processing.

Various examples may include the computer platform using one or more artificial intelligence engines to extract the information conveyed in the unverified digital communication and the information conveyed in the at least one of the plurality of authenticated digital communications. The computer platform may determine a conditional probability of the information in the unverified digital communication given the information conveyed in the at least one of the plurality of authenticated digital communications, wherein the degree of accuracy is based on the conditional probability.

Various aspects involve using entropy analysis to determine the authenticity score and/or the degree of accuracy of the unverified digital communication. For example, the computing platform may determine the entropy of the information conveyed in the unverified digital communication, wherein the entropy depends on the information conveyed in at least one of the plurality of authenticated digital communications and wherein the authenticity score is based on the entropy. For example, determining the entropy may include the computer platform determining a conditional entropy of the information conveyed in the unverified digital communication conditioned on the information conveyed in the at least one of the plurality of authenticated digital communications. Determining the entropy may include the computer platform determining a relative entropy with respect to the information conveyed in the at least one of the plurality of authenticated digital communications.

In some examples, to determine the relative entropy, the computer platform may determine a first probabilistic distribution of the information conveyed in the unverified digital communication, determine a second probabilistic distribution of the information conveyed in the at least one of the plurality of authenticated digital communications, and determine the relative entropy based on a difference between the first probabilistic distribution and the second probabilistic distribution.

In some examples, the computer platform may identify a first subset of time intervals within the at least one of the plurality of authenticated digital communications, identify a second subset of time intervals within the at least one of the plurality of authenticated digital communications, detect a first entropy of the information conveyed in the unverified digital communication based on the first subset of the time intervals, and detect a second entropy of the information conveyed in the unverified digital communication based on the second subset of the time intervals. Based on the second entropy being greater than the first entropy, the computer platform may determine that the unverified digital communication is an altered version of at least one of the plurality of authenticated digital communications.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for the determination of an authenticity score of an unverified digital communication in accordance with one or more aspects described herein;

FIGS. 2A-2B depict digital communications and a tamper-proof data structure in accordance with one or more aspects described herein;

FIG. 3 depicts a method for quantum-resistant hashing of and storage of digital communications on tamper-proof quantum-resistant chains according to one or more aspects described herein;

FIG. 4 depicts a method for receiving and responding to authentication requests for an unverified digital communication according to one or more aspects described herein;

FIG. 5 depicts a method for encoding authenticated digital communications into tamper-proof distributed ledgers according to one or more aspects described herein;

FIG. 6 depicts a method for determining an authentication score according to one or more aspects described herein;

FIG. 7 depicts a method for determining the entropy of a digital communication according to one or more aspects described herein;

FIG. 8 depicts a method for determining the relative entropy of a digital communication according to one or more aspects described herein;

FIG. 9 depicts a method for detecting an altered version of an authenticated digital communication according to one or more aspects described herein; and

FIG. 10 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof and illustrate various embodiments in which aspects of the disclosure may be practiced. It is to be understood that other embodiments may be utilized, and structural and functional modifications may be made without departing from the scope of the present disclosure.

The following description discusses various connections between elements. These connections are general and, unless specified otherwise, may be direct or indirect, wired or wireless, and the specification is not intended to be limiting in this respect.

As discussed above, misinformation and disinformation are present problems due to the easy manipulation of public communications over digital platforms and the rapid pace at which manipulated communications are disseminated. The user's inability to verify received information leads to an inability to rely on the information in practical ways, such as making economic or investment decisions or using the information in scientific analysis. For instance, a CEO of a publicly traded company could put out a press release or stream an audio/video announcement over the Internet to shareholders to report quarterly earnings that beat forecasted expectations. A bad actor using a generative AI could capture and manipulate the announcement to generate a convincing altered copy that indicates that the company did not meet expectations. The bad actor can then spread the altered copy (e.g., through social media) as disinformation to manipulate stock investors and the company's stock price maliciously.

Accordingly, aspects described herein are directed to detecting altered and false digital communications by maintaining authentic publicly disseminated digital communications securely in a publicly available repository. Using secure and authentic digital communications, aspects provide a way to quickly verify whether unverified digital communications are genuine and unaltered versions of authentic communications or convey the same information. This may include on-the-fly (e.g., in real-time) hashing (e.g., with a quantum-resistant hash) the authentic digital communications as they are transmitted over a public electronic medium and storing the hashed digital communication in a tamper-proof quantum-resistant distributed ledger. The tamper-proof quantum-resistant distributed ledger may be stored in a publicly accessible repository (e.g., one or more servers). A subsequent unverified digital communication may then be analyzed to determine an authenticity score indicating, for example, how likely the unverified digital communication accurately conveys the same information as in the stored authentic digital communication. These and various other arrangements will be discussed more fully below.

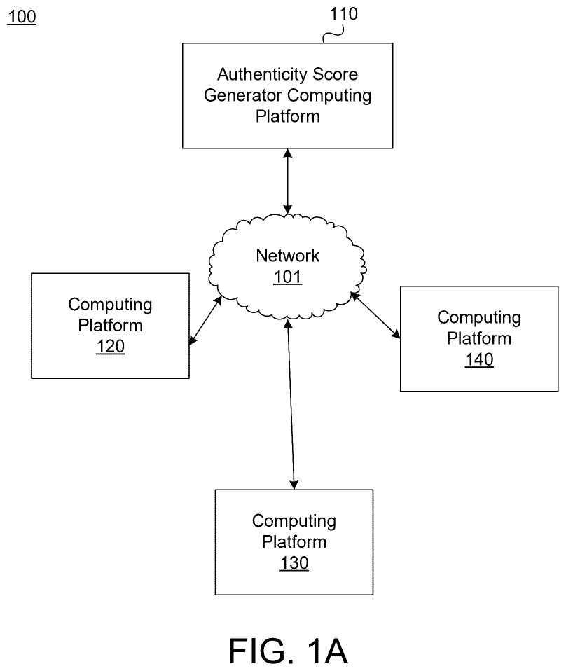

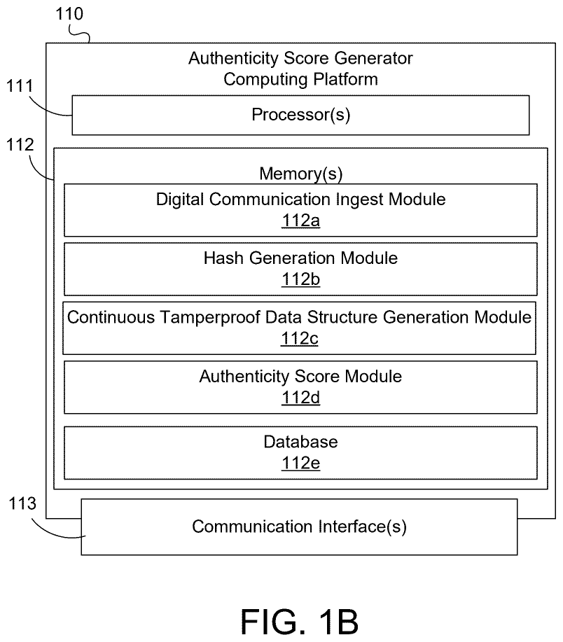

FIGS. 1A-1B depict an illustrative computing environment for the determination of an authenticity score of an unverified digital communication in accordance with one or more aspects described herein.

Referring to FIG. 1A, computing environment 100 may include one or more computing devices and/or other computing systems. For example, computing environment 100 may include an authenticity score generator computing platform 110, first computing device 120, second computing device 130, and third computing device 140. Although four computing devices are shown, any number of systems or devices may be used without departing from the invention.

Authenticity score generator computing platform 110 may be configured to perform intelligent, dynamic, real-time, and continuous monitoring of digital communications transmitted over one or more public electronic mediums from one or more sources (e.g., from trusted sources), hashing of the data (e.g., using quantum-resistant hashing algorithms) and encoding of the hashed data in a tamper-proof distributed ledger, such as a quantum-resistant blockchain. The digital communication, once stored in the tamper-proof disturbed ledger, may be treated as an authenticated digital communication. The authenticated digital communications may then be used as a basis for verifying the authenticity of subsequent communications. As used herein for conciseness, digital communication may include text data, audio data, and/or video data, which may also be referred to generally as communication data. Public electronic mediums include the Internet, World-Wide Web, cable systems, satellite systems, over-the-air broadcasts, cellular systems, and other mediums.

Authenticity score generator computing platform 110, and the first computing device 120, the second computing device 130, and/or the third computing device 140 may be or include one or more computer components (e.g., servers, server blades, memory, processors, or the like) and may each include systems, applications, and the like, for receiving, decoding, storing, and/or presenting digital communications. Accordingly, the first computing device 120, the second computing device 130, and/or the third computing device 140 may be a plurality of computing devices in a system for processing digital communications. They may communicate with each other via machine-to-machine communication or data exchange to process digital communication data.

As mentioned above, computing environment 100 may also include one or more networks, which may interconnect one or more of the authenticity score generator computing platform 110, the first computing device 120, the second computing device 130, and/or the third computing device 140. For example, computing environment 100 may include network 101, which may be a public or private network. Network 101 may include one or more sub-networks (e.g., Local Area Networks (LANs), Wide Area Networks (WANs), or the like). Network 101 may interconnect one or more computing devices associated with an organization with other devices, such as computers of individuals or other organizations that consume and share digital communications. For example, authenticity score generator computing platform 110, first computing device 120, second computing device 130, and/or third computing device 140 may be connected via network 101.

Referring to FIG. 1B, authenticity score generator computing platform 110 may include one or more processors 111, memory 112, and communication interface 113. A data bus may interconnect processor(s) 111, memory 112, and communication interface 113. Communication interface 113 may be a network interface configured to support communication between authenticity score generator computing platform 110 and one or more networks (e.g., network 101 or the like). Memory 112 may include one or more program modules having instructions that, when executed by processor(s) 111, cause computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of computing platform 110 and/or by other computing devices that may form and/or otherwise make up computing platform 110.

For example, memory 112 may have, store, and/or include a digital communication ingest module 112a that may store instructions and/or data that may cause or enable the computing platform 110 to receive digital communications and metadata as further described below from other computing platforms such as first computing device 120, second computing device 130 and/or third computing device 140 from different data sources (different disseminators or digital communications). Computing platform 110 may further have, store, and/or include hash generation module 112b. Hash generation module 112b may store instructions and/or data that may cause or enable the computing platform 110 to generate hashes or tokens, including quantum-resistant hashes based on received digital communications, including text, audio, and/or video data and metadata. The received digital communications may include original digital communications and copies or portions of original digital communications. Hash generation module 112b may store instructions and/or data that may cause or enable the computing platform 110 to generate hashes or tokens, including quantum-resistant hashes based on headers for blocks in a quantum-resistant chain.

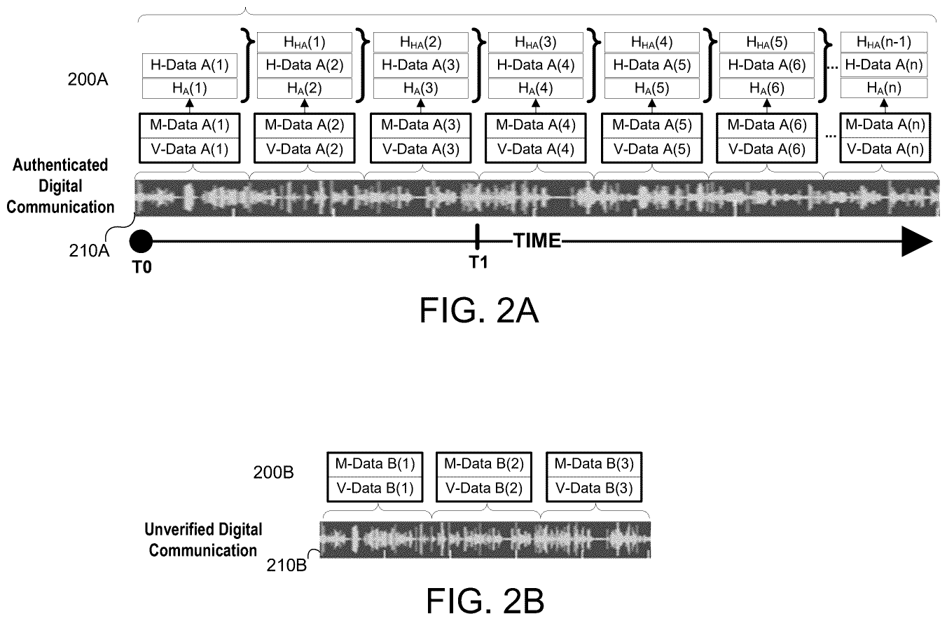

Computing platform 110 may further have, store, and/or include a tamperproof data structure generation module 112c that may generate (e.g., continuously) tamperproof data structures such as those described below with respect to FIG. 2 using digital communication data, metadata, and hashes generated by modules 112a-b.

Computing platform 110 may further have, store, and/or include authenticity score module 112d that generates an authenticity score for unverified digital communication based on the authenticated digital communications stored in the tamperproof data structures. Authenticity score module 112d may use various data matching algorithms, artificial intelligence, and large language modules to recognize information in digital communications, and entropy analysis algorithms used to generate the authenticity score, as is further described below.

Computing platform 110 may further include database 112e. Database 112e may store data related to unverified data communications and data related to the tamper-proof data structures, including authenticated digital communication data, metadata hashes of the voice/metadata, header data, and hashes of headers and/or other data to perform the functions of the computing platform 110.

Computing platforms 120, 130, and 140 may each include some or all of the components included in computing platform 110, as illustrated and described with respect to FIG. 1B.

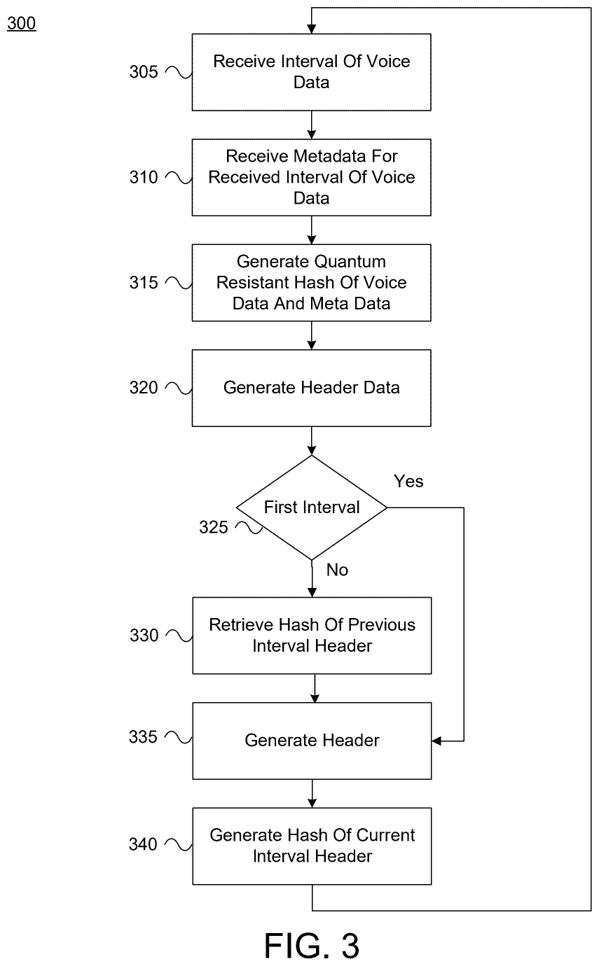

FIG. 2A depicts an example illustrative tamper-proof data structure (e.g., using distributed ledger technology) that includes an authenticated digital communication that may be generated according to a process 300 illustrated in FIG. 3, which may provide digital communication hashing and tamper-proof encoding in accordance with one or more aspects described herein. FIG. 2B depicts an example data structure of an unverified digital communication. The data structures in FIGS. 2A and 2B are merely a few examples, and other data structures may be encoded without departing from the invention. For example, the data structures in FIG. 2A may be formed as blockchains (or other linked lists), sidechains (or other lists of linked lists), or directed acyclic graphs, such as tangles or hash graphs. The tamper-proof encoding may alternatively or additional use lattice-based cryptography, code-based cryptography, and multivariate cryptography.

Process 300 in FIG. 3 is merely one example sequence, and additional steps may be added or omitted. The steps may be performed in different orders than illustrated without departing from the invention. Process 300 may be performed in real-time and/or continuously, for example, as digital communications are generated from data sources (e.g., a streaming or broadcast source). Additionally, or alternatively, process 300 may be performed on data digital communication after the digital communication has been generated and stored, e.g., in a database. Additionally or alternatively, process 300 (or parts thereof) may be performed on digital copies, as shown in FIG. 2B, which may be unaltered or altered copies of all or portions of an authenticated digital communication, as illustrated in FIG. 2A.

FIG. 2A illustrates a tamper-proof chain of data generated from a digital communication (e.g., video and/or audio), for example, transmitted over a public electronic medium, such as the Internet. While the communication is generally referred herein to as text, video, or audio, the communication could be any electronic communication transmitted from a source and received by one or more destinations, either point-to-point (e.g., a phone call), from one-to-many (e.g., in a conference call, or stream), or one-to-all (e.g., in a broadcast), such as between computer platforms 120, 130, and 140 (e.g., personal computers). The digital communication may be human or computer generated.

From a source (e.g., computer platform 120), digital communication 210A may be generated and communicated (e.g., transmitted) to destinations (e.g., communication platforms 110, 130, and 140). Generally, digital communication 210A as it is transmitted from the source (e.g., 120) will be identical or nearly identical to as it is received (e.g., at 110, 130, 140) because of its digital encoding, which may include mechanisms for error detection and corrections.

The digital communication may be divided into intervals (e.g., every 1 nanosecond, 1 microsecond, 1 millisecond, 1 second, 10 seconds, etc.) over the duration of the digital communication. For example, digital communication 210A may be divided into sequential intervals V-Data A(1) through V-Data A(n). In some examples, the interval size for each caller may be the same, though in others, they may be different sizes. In some examples, for each interval of the digital communication, there may be metadata that is generated (e.g., by computer platforms 110, 120, 130, or 140), that includes information like dates and times the interval of digital communication was generated, interval size, a file name the digital communication is contained in, coding format of the digital communication, etc. For example, V-Data A(1) through V-Data A(n) may have associated therewith, metadata M-Data A(1) through M-Data A(n), respectively.

FIG. 2B illustrates an example of an unverified digital communication 210B, which may be an altered or unaltered copy of digital communication 210A or convey the same or similar information as information conveyed in digital communication 210A. Unverified digital communication 210B may be generated by a receiver (e.g., 110, 130, or 140) of the original digital communication transmitted by the source (e.g., 120). Aspects are directed to determining whether unverified digital communication 210B is an unaltered copy of or conveys the same information as a portion of digital communication 210A. Similar to the authenticated digital communication, unverified digital communication 210B may be divided into intervals (e.g., every 1 nanosecond, 1 microsecond, 1 millisecond, 1 second, 10 seconds, etc.) over the duration of the digital communication. For example, unverified digital communication 210B may be divided into sequential intervals, such as V-Data B(1) through V-Data B(m) (only the first three intervals are shown, for example). Like the intervals of the authenticated digital communication, the intervals of the unverified digital communication V-Data B(1) through V-Data B(n) may have associated therewith, metadata M-Data B(1) through M-Data B(n), respectively. One or more sequential intervals and metadata of unverified digital communication 210B may match the corresponding intervals and metadata of the original communication 210A. In some examples, one or more of the sequential intervals and metadata of unverified digital communication 210B may be an altered version (e.g., a deepfake) of the corresponding intervals and metadata of the original communication 210A.

For each interval of digital communication 210A and optionally corresponding metadata, a corresponding header is generated. Together, the interval of digital communication, metadata, and header form a block of data in a tamper-proof data structure. With reference to FIG. 3, to encode the digital communication in FIG. 2A in a tamper-proof data structure, a computing platform such as 110, 120, 130, and/or 140 may receive in step 305 an interval of digital communication (e.g., V-Data A(1)) and optionally receive in step 310 the metadata corresponding to the interval of digital communication (e.g., M-Data A(1)).

At step 315, a computing platform such as 110, 120, 130, and/or 140 may generate a hash or token (e.g., H_{A}(1)) based on the received digital communication interval (e.g., V-Data A(1)), and optionally, the corresponding metadata (e.g., M-Data A(1)). The cryptographic hashing algorithm to generate the hash or token may be quantum-resistant, such that it is secure against attacks with a quantum computer (e.g., running Shor's Algorithm). Examples of quantum-resistant cryptographic hashing algorithms include Lamport signatures, Merkle signature schemes, Extended Merkle signature scheme (XMSS), SPHINCS, SPHINCS+, Crystals-Dilithium, FALCON, etc.

At step 320, for an interval of digital communication, a computing platform such as 110, 120, 130, and/or 140 may generate header data. For example, for V-Data A(1), header data H-Data A(1) may be generated. Upon completion of process 300, header data may be generated for some or all of each interval of digital communication 210A. For example, in FIG. 2A, V-Data A(1) through V-Data A(n) may have associated therewith, header data H-Data A(1) through H-Data A(n), respectively.

The header data for each block may include information about the communication and information about the tamper-proof data structure. Information about the communication may include, for example, information identifying the source, about the computing platforms or network connections, such as IP and MAC addresses and the computing platforms'geographical and/or physical locations, etc. Information about the tamper-proof data structure may include, for example, a timestamp of when the header was created, memory pointers to the digital communication, metadata, and other information in the block, memory pointers to one or more preceding blocks, a cryptographic nonce, a pointer to a root node or leaf node (e.g., in a Merkle tree), etc.

At step 325, a computing platform such as 110, 120, 130, and/or 140 may determine whether the corresponding digital communication interval for the block is the first interval of the digital communication, for example, such as V-Data A(1). If the digital communication interval is not the first interval, the process may proceed to step 330, in which a computing platform such as 110, 120, 130, and/or 140 retrieves a hash of the header for the previous data block (e.g., including the previous interval of digital communication). From step 330, the process may proceed to step 335. If in step 325, the digital communication interval is the first interval, the process may skip to step 330 and proceed to step 335.

At step 335, a computing platform such as 110, 120, 130, and/or 140 may generate a header for the block, which may include the hash of the digital communication (and optionally metadata) for the current interval (e.g., H_{A}(1), H_{A}(2), etc.), the header data for the current interval (e.g., H-Data A(1), H-Data A(2)). If the current block is not the first block, the header may include the hash of the previous block's header (e.g., H_{HA}(1), etc.).

At step 340, a computing platform such as 110, 120, 130, and/or 140 may generate a hash or token (e.g., H_{HA}(1), H_{HA}(2), etc.) based on the current header (e.g., including H-Data A(1) and H_{A}(1), including H-Data A(2) and H_{A}(2), and H_{HA}(1), etc.). Similar to the cryptographic hashing algorithm for the voice and metadata, the cryptographic hashing algorithm for the header may generate a quantum-resistant hash or token, such that it is secure against attacks with a quantum computer (e.g., running Shor's Algorithm). In these examples, the header data and/or the hash of the previous header provide a secure link between each block and make the encoding of each block dependent upon the previous block(s), which, together with the quantum-resistant hashes, make the data structure resistant to tampering (e.g., with a quantum computer). While the examples include a linear link of blocks, other quantum-resistant structures that include linked blocks may be used, including Lamport signatures, Merkle signature schemes, Extended Merkle signature scheme (XMSS), SPHINCS, SPHINCS+, Crystals-Dilithium, FALCON, etc.

After step 340, the process may return to step 305 to process the next interval of digital communication. Process 300 may continue for each data source of digital communication until the voice ends. This may result in a tamper-proof data structure 200A including digital communication V-Data A(1) through V-Data A(n), metadata M-Data A(1) through M-Data A(n), digital communication hashes H_{A}(1) through H_{A}(n), header data H-Data A(1) through H-Data A(n), and header hashes H_{HA}(1) through H_{HA}(n-1). Examples of process 300 may combine steps or perform certain steps in different orders. For example, step 325 may be eliminated, and step 330 may retrieve a null value if the interval is the first block. In another example, step 340 may performed at any time in any sequence when all header data for the block has been determined. Process 300 may be performed continuously and/or in real-time, for example, as each interval of digital communication is generated during a call, or may be performed after some or all of the digital communication is generated and stored in a memory.

In various examples, the performance of process 300 may be performed by a single computing platform 110, 120, 130, and/or 140, or the steps of process 300 may be distributed amongst the computing platforms. For example, the retrieval of the digital communication and metadata, and the generation of the hash of the digital communication and metadata may be performed by the computing platform from which the digital communication originates. Generation of the header data and the hash for the header data may be performed by computing platform 110. As an alternative, computing platform 110 may perform the entirety of process 300. In other examples, computing platforms 110, 120, 130, and/or 140, together, perform the steps of process 300 for a single data source.

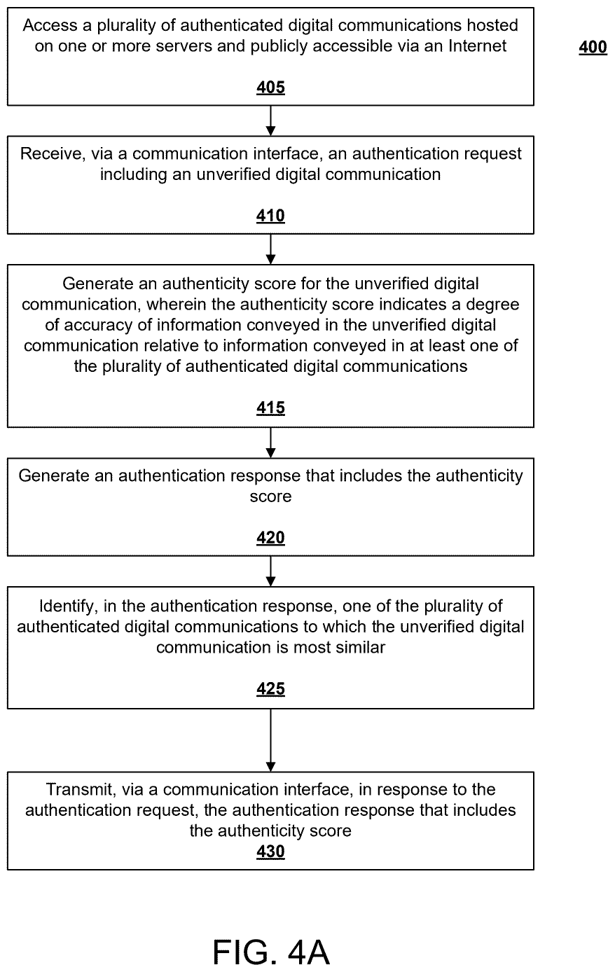

FIG. 4 depicts a method for receiving and responding to authentication requests for an unverified digital communication. In FIG. 4, process 400 begins with step 405, in which a computing platform (e.g., 110) may include at least one processor, a communication interface communicatively coupled to the at least one processor, and a memory storing computer-readable instructions that cause the computing platform to access a plurality of authenticated digital communications hosted on one or more servers and publicly accessible via the Internet. The computer platform (e.g., 110), for example, may access the plurality of authenticated digital communications maintained on the one or more servers (e.g., 110, 120, 130, 140) and encoded in a plurality of tamper-proof distributed ledgers as described above with respect to FIGS. 2A and 3.

Users may use the repository to verify whether unverified digital communications or portions of digital communications are authentic and unmodified, altered versions of the digital communications, or do not match any of the digital communications in the repository. For example, a company that streams an earnings report on the Internet may encode the stream in a tamper-proof distributed ledger in the repository. The streamed report may be posted on the company's website along with a link to the repository to verify any copies of the report. One application may be in news reporting. A news organization may include a clip of the report on the news organization's website or in a post on a social media platform and include a link to the stream in the repository with the clip. In this way, a reader can verify for themselves if the clip is a genuine copy of the stream or if it is doctored or altered, e.g., to include misinformation or disinformation.

In step 410, the computer-readable instructions may cause the computing platform (e.g., 110) to receive, via the communication interface, an authentication request that includes an unverified digital communication. The authentication request may include instructions or an indication to determine the unverified digital communication accuracy with respect to the plurality of authenticated digital communications maintained in the plurality of tamper-proof distributed ledgers. The authentication request may be an electronically transmitted message (e.g., via network 101). In some examples, the computer platform may provide an interface (e.g., website) through which a requester can submit the request.

In step 415, the computer-readable instructions may cause the computing platform (e.g., 110) to generate an authenticity score for the unverified digital communication. The authenticity score may indicate a degree of accuracy of information conveyed in the unverified digital communication relative to information conveyed in at least one of the plurality of authenticated digital communications. A low authenticity score may indicate, for example, that the unverified digital communication is an altered version of one of the authenticated digital communications, and a high authenticity score may indicate an accurate representation of one of the authenticated digital communications. For example, the authenticity score may be a value from zero to one, with zero representing no similarity between the unverified digital communication and the plurality of authenticated digital communications and one representing an exact match of the information conveyed in the unverified digital communication relative to information conveyed in at least one of the plurality of authenticated digital communications.

Authenticity can refer to data in the unverified digital communication having the same values (e.g., digital values) as the data in the plurality of authenticated digital communications. In some examples, the unverified digital communication does not need to be an exact copy to have a high correspondence (and thus a high authenticity score) to one or more authenticated digital communications. For example, an unverified digital communication could have a higher authenticity score by conveying the same information as in an authenticated digital communication but do so in a different language (e.g., English, Japanese, American Sign Language, etc.), a different medium (e.g., text and an image that convey the same information, audio and video that convey the same information, etc.), or in the form of a summary of the original content (e.g., human-generated or AI generated summaries), etc.

In other examples, the unverified digital communication may include information about the same event captured in the information of the authenticated digital communication but captured separately and/or from a different position or perspective. For example, the authenticated digital communication may include audio and/or video captured from a first participant in a conference call, while the unverified digital communication may include audio and/or video from a second participant in the same conference. The unverified digital communication may include a human-generated or AI-generated summary of the conference call. Using the authenticated digital communication as the benchmark, the authenticity score for the unverified digital communication may indicate the degree to which the information in the unverified digital communication is accurate (e.g., by indicating the degree to which the information in the unverified digital communication corresponds to the information conveyed in the authenticated digital communication).

In some examples, multiple authenticated digital communications may serve as the benchmark for generating an authenticity score. For instance, multiple news broadcasts (e.g., ABC, CNN, FOX) capturing a common event (e.g., a public speech, natural disaster, local legislative session, armed conflict, etc.) may be stored as multiple authenticated digital communications, respectively. The computing platform (e.g., 110) may compute the probabilistic content of the information included within the multiple authenticated digital communications.

In some variations, in step 415, the computer platform may receive, in the authentication request, an identification of one of the plurality of authenticated digital communications (e.g., a news broadcast) and generate the authenticity score using the identified one of the plurality of authenticated digital communications as a benchmark for the authenticity score.

In some variations, the computer platform may generate the authenticity score further based on other factors. Other factors may include one or more of: the authentication request being received from a trusted network domain, the authentication request being received from a domain having a registrant being identified in a trusted party list, and the unverified digital communication being accessible via a uniform resource locator (URL) identified in an enterprise APL approved list.

In step 420, the computer-readable instructions may cause the computing platform (e.g., 110) to generate an authentication response that includes the authenticity score. In step 425, the computer-readable instructions may cause the computing platform (e.g., 110) to identify, in the authentication response, one of the plurality of authenticated digital communications to which the unverified digital communication is most similar.

In step 430, the computer-readable instructions may cause the computing platform (e.g., 110) to transmit, via the communication interface, in response to the authentication request, an authentication response that includes the authenticity score. For example, the computer platform may transmit (e.g., via network 101) a message to another computer platform (e.g., 120) from which the authentication request was received. In examples where the computing platform provides a web server interface, the authentication response may be in the form of a webpage displaying the authenticity score. In some examples, the computer platform receives authenticity requests and responds with authenticity responses as a validation as a service (VAAS) tool, for example, to enable users to detect and prevent misinformation and disinformation.

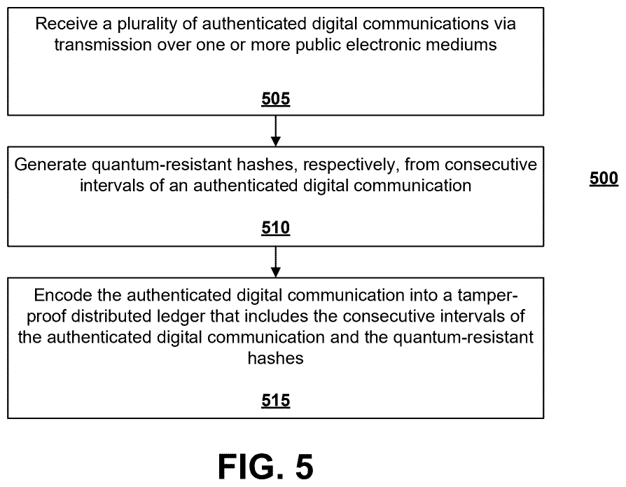

FIG. 5 depicts a process for encoding authenticated digital communications into tamper-proof distributed ledgers. Process 500 in FIG. 5 may be performed by the same or different computing platform (or platforms) as the computing platform that performs process 400 illustrated in FIG. 4. Process 500 may be performed separately or as part of process 400. Process 500 begins with step 505, in which a computing platform (e.g., 110) may include at least one processor, a communication interface communicatively coupled to the at least one processor, and a memory storing computer-readable instructions that cause the computing platform (e.g., 110) to receive the plurality of authenticated digital communications via transmission over one or more public electronic mediums. In some examples, the computing platform that receives the digital communications may be the same as the computing platform that transmits them. That is, a computing platform may transmit a digital communication and also keep a copy of the transmission for further processing according to Process 400. As discussed above, the plurality of digital communications comprises audio data or video data received via the Internet. One or more public electronic mediums may include transmission over a communication network via a web application, a broadcast transmission, or a multicast transmission. For example, the transmission may be over a cable (e.g., fiber or coax cable), over the air from a satellite, over the air from a ground-based antenna, or over the air from a cellular tower. The medium may be any wired or wireless radio-frequency transmission. In some examples, one or more public electronic mediums include transmission of the plurality of digital communications (e.g., in packets) via a World Wide Web or the Internet, e.g., through a plurality of networks, including home wireless or wired networks. The plurality of digital communications may be accessible to anyone with access to the one or more public electronic mediums.

In step 510, the computer-readable instructions may cause the computing platform (e.g., 110) to generate quantum-resistant hashes, respectively, from consecutive intervals of an authenticated digital communication. In step 515, the computer-readable instructions may cause the computing platform (e.g., 110) to encode the authenticated digital communication into a tamper-proof distributed ledger that includes the consecutive intervals of the authenticated digital communication and the quantum-resistant hashes. At least one iteration of process 500 may be performed prior to the performance of process 400 such that there is at least one authenticated digital communication stored in the one or more servers and available for determining an authenticity score. In some aspects, each digital communication may be encoded as previously discussed with respect to FIGS. 2A and 3, for example, by a computer platform performing process 300. For example, encoding a digital communication may include generating quantum-resistant hashes, respectively, from consecutive intervals of the digital communication as discussed above with respect to step 315, and include the consecutive intervals of the digital communication and the quantum-resistant hashes into one of the plurality of tamper-proof distributed ledgers corresponding to the digital communication as discussed above with respect to steps 320-340.

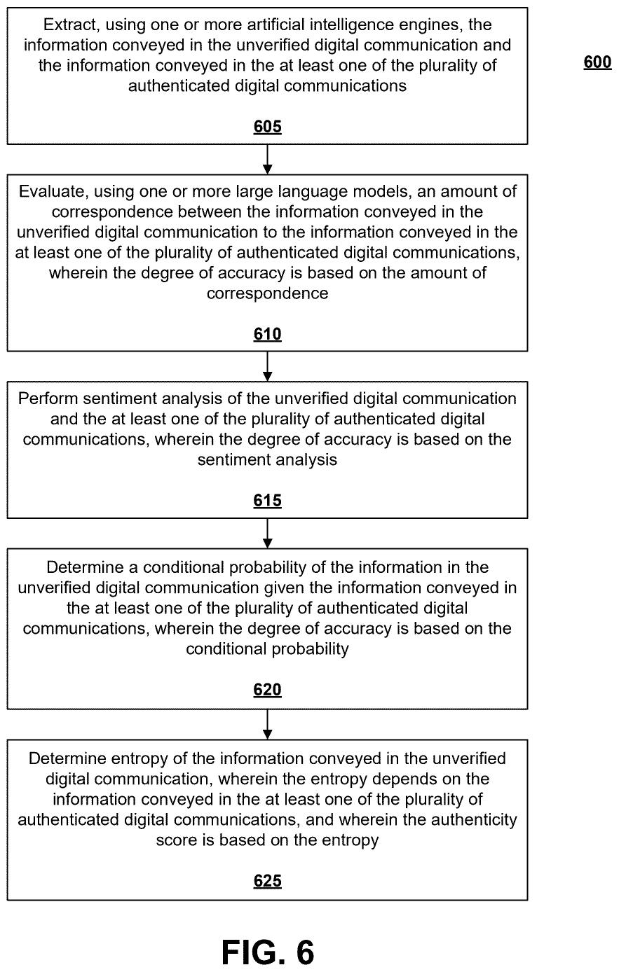

FIG. 6 depicts a process 600 including various steps for determining an authentication score. Process 600, for example, may be used in step 415 of process 400. Process 600 includes step 605, in which a computing platform (e.g., 110) may include at least one processor, a communication interface communicatively coupled to the at least one processor, and a memory storing computer-readable instructions that cause the computing platform (e.g., 110) to extract, using one or more artificial intelligence engines, the information conveyed in the unverified digital communication and the information conveyed in at least one of the plurality of authenticated digital communications. The extracted information may include the exact data in the digital communications, or may include information conveyed in the data, either in the same form or in another (e.g., synonymous) form as the original data as described above with respect to step 415.

In step 610, the computer-readable instructions may cause the computing platform (e.g., 110) to evaluate, using one or more large language models, an amount of correspondence between the information conveyed in the unverified digital communication to the information conveyed in the at least one of the plurality of authenticated digital communications. The degree of accuracy, e.g., as determined in step 415 above, may be based on the amount of correspondence.

In step 615, the computer-readable instructions may cause the computing platform (e.g., 110) to perform sentiment analysis of the unverified digital communication and the at least one of the plurality of authenticated digital communications. Performing the sentiment analysis may be based on natural language processing, voice processing, or image processing. The degree of accuracy, e.g., as determined in step 415 above, may be based on the sentiment analysis.

In step 620, the computer-readable instructions may cause the computing platform (e.g., 110) to determine a conditional probability of the information in the unverified digital communication given the information conveyed in at least one of the plurality of authenticated digital communications. The “informational value” of the unverified digital communication may depend on the degree to which the content of the message is surprising. If a highly likely event occurs, the unverified digital communication carries very little information. On the other hand, if a highly unlikely event occurs, the unverified digital communication is much more informative. In the context of determining the conditional probability of the information conveyed in the unverified digital communication, the probability will be high (e.g., close to 1) if it is similar to the previously authenticated digital communications (and thus, less surprising and with low information value), whereas any unverified digital communication, for example, with misinformation or disinformation will have low probability (and thus more surprising and with high information content). The degree of accuracy, e.g., as determined in step 415 above, may be based on the conditional probability.

In step 625, the computer-readable instructions may cause the computing platform (e.g., 110) to determine the entropy of the information conveyed in the unverified digital communication. The entropy may depend on the information conveyed in at least one of the plurality of authenticated digital communications. The entropy quantifies the average level of uncertainty or information associated with the potential states of the unverified digital communication. An unverified digital communication that is similar to the authenticated digital communications may have a low entropy rise, whereas unverified digital communication that is similar to the authenticated digital communications may have a low entropy rise. The degree of accuracy, e.g., as determined in step 415 above, may be based on the entropy.

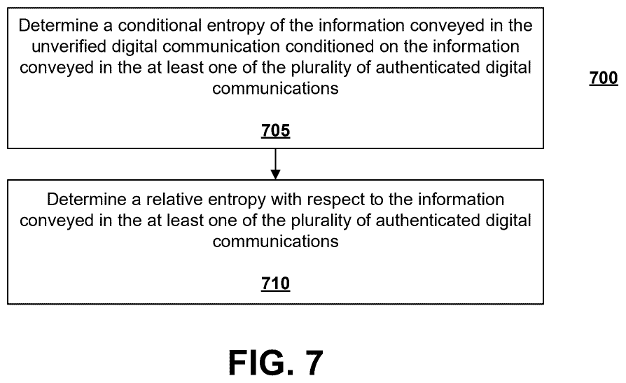

FIG. 7 depicts a process 700 for providing different ways of determining the entropy of a digital communication. One or more of the steps of process 700 may be used for determining the entropy in step 625 of process 600. Process 700 may include step 705, in which a computing platform (e.g., 110) may include at least one processor, a communication interface communicatively coupled to the at least one processor, and a memory storing computer-readable instructions that cause the computing platform (e.g., 110) to determine a conditional entropy of the information conveyed in the unverified digital communication conditioned on the information conveyed in the at least one of the plurality of authenticated digital communications. The conditional entropy may be zero if the information conveyed in the unverified digital communication is completely determined by the information conveyed in one or more of the authenticated digital communications. In some examples, the entropy of the unverified digital communication is determined without considering the authenticated digital communications (e.g., unconditional). An increase in the unconditional entropy over the conditional entropy may be indicative of differences or changes in the information conveyed in the unverified digital communication as compared to the information conveyed in one or more of the authenticated digital communications. This increase may be indicative of a lower degree of accuracy, e.g., as determined in step 415 above.

In step 710, the computer-readable instructions may cause the computing platform (e.g., 110) to determine a relative entropy with respect to the information conveyed in at least one of the plurality of authenticated digital communications. The relative entropy may measure how much the probability distribution of the information conveyed in the unverified digital communication differs from the probability distribution of the information conveyed in one or more of the authenticated digital communications.

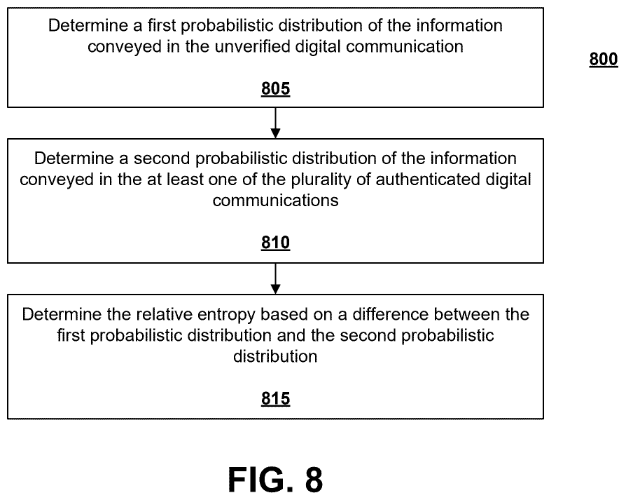

FIG. 8 depicts process 800 for determining the relative entropy of a digital communication, for example, as provided in step 710 of process 700. Process 800 includes step 805, in which a computing platform (e.g., 110) may include at least one processor, a communication interface communicatively coupled to the at least one processor, and a memory storing computer-readable instructions that cause the computing platform (e.g., 110) to determine a first probabilistic distribution of the information conveyed in the unverified digital communication. In step 810, the computer-readable instructions may cause the computing platform (e.g., 110) to determine a second probabilistic distribution of the information conveyed in at least one of the plurality of authenticated digital communications. In step 810, the second probabilistic distribution may be based on the information conveyed in multiple or all of the authenticated digital communications. In step 815, the computer-readable instructions may cause the computing platform (e.g., 110) to determine the relative entropy based on a difference between the first probabilistic distribution and the second probabilistic distribution.

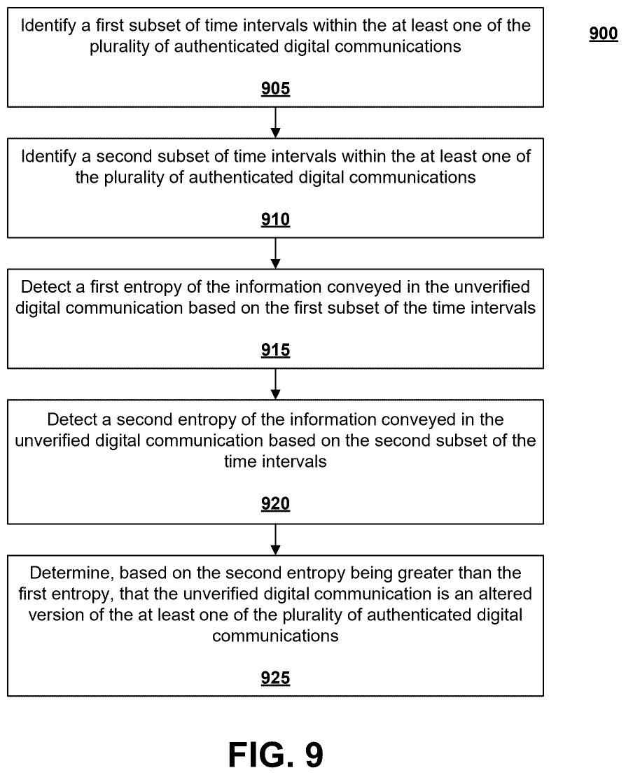

FIG. 9 depicts a process 900 for detecting an altered version of an authenticated digital communication. Process 900 includes step 905, in which a computing platform (e.g., 110) may include at least one processor, a communication interface communicatively coupled to the at least one processor, and a memory storing computer-readable instructions that cause the computing platform (e.g., 110) to identify a first subset of time intervals within at least one of the plurality of authenticated digital communications. In step 910, the computer-readable instructions may cause the computing platform (e.g., 110) to identify a second subset of time intervals within the at least one of the plurality of authenticated digital communications. In step 915, the computer-readable instructions may cause the computing platform (e.g., 110) to detect a first entropy of the information conveyed in the unverified digital communication based on the first subset of the time intervals. In step 920, the computer-readable instructions may cause the computing platform (e.g., 110) to detect a second entropy of the information conveyed in the unverified digital communication based on the second subset of the time intervals. In step 925, the computer-readable instructions may cause the computing platform (e.g., 110) to determine, based on the second entropy being greater than the first entropy, that the unverified digital communication is an altered version of the at least one of the plurality of authenticated digital communications.

In some examples, the first subset of time intervals may be a duration of the authenticated digital communications that matches a first corresponding duration of the unverified digital communication, which causes a lower first entropy. The second subset of time intervals may be a duration of the authenticated digital communications that does not match a second corresponding duration of the unverified digital communication, which causes a higher second entropy. By determining that some durations match (e.g., have low entropy) where other durations differ (e.g., have high entropy), the computing platform may determine that the unverified digital communication includes misinformation or disinformation, such as being a deepfake based on the authenticated digital communications.

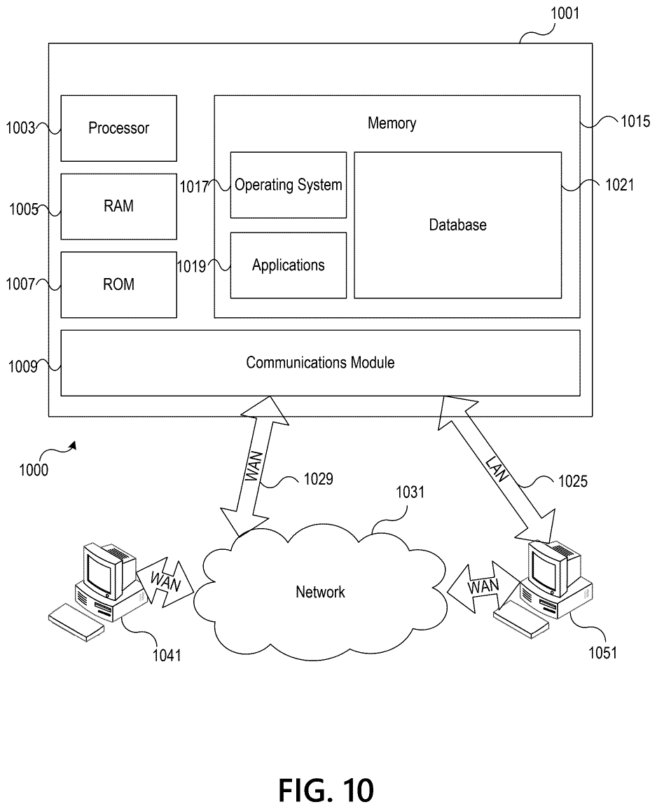

FIG. 10 depicts an illustrative operating environment in which various aspects of the present disclosure may be implemented in accordance with one or more example embodiments. Computing System Environment 1000 is only one example of a suitable computing environment. It is not intended to suggest any limitation regarding the scope of use or functionality contained in the disclosure. Computing System Environment 1000 should not be interpreted as having any dependency or requirement relating to any one or combination of components shown in illustrative Computing System Environment 1000. Computing System Environment 1000 elements for implementing any of the computing platforms (e.g., 110, 120, 130, 140) in addition or as an alternative to those elements as described above with respect to FIGS. 1A-1B.

Computing system environment 1000 may include processor 1003 for controlling the overall operation of computing device 1001 and its associated components, including Random Access Memory (RAM) 1005, Read-Only Memory (ROM) 1007, communications module 1009, and memory 1015. Computing device 1001 may include a variety of computer-readable media. Computer-readable media may be any available media that may be accessed by computing device 1001, may be non-transitory, and may include volatile and nonvolatile, removable and non-removable media implemented in any method or technology for storage of information such as computer-readable instructions, object code, data structures, program modules, or other data. Examples of computer-readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 1001.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor (e.g., hardware processor) on computing device 1001. Such a processor may execute computer-executable instructions stored on a computer-readable medium.

Software may be stored within memory 1015 and/or storage to provide instructions to processor 1003 for enabling computing device 1001 to perform various functions as discussed herein. For example, memory 1015 may store software used by computing device 1001, such as operating system 1017, application programs 1019, and associated database 1021. Also, some or all of the computer-executable instructions for computing device 1001 may be embodied in hardware or firmware. Although not shown, RAM 1005 may include one or more applications representing the application data stored in RAM 1005 while computing device 1001 is on and corresponding software applications (e.g., software tasks) are running on computing device 1001.

Communications module 1009 may include a microphone, keypad, touch screen, and/or stylus through which a user of computing device 1001 may provide input. It may also include one or more speakers for audio output and a video display device for textual, audiovisual, and/or graphical output. Computing system environment 1000 may also include optical scanners (not shown).

Computing device 1001 may operate in a networked environment supporting connections to one or more remote computing devices, such as 1041 and 1051. Computing devices 1041 and 1051 may be personal computing devices or servers that include any or all of the elements described above relative to computing device 1001.

The network connections depicted in FIG. 10 may include Local Area Network (LAN) 1025 and Wide Area Network (WAN) 1029, as well as other networks. When used in a LAN networking environment, computing device 1001 may be connected to LAN 1025 through a network interface or adapter in communications module 1009. When used in a WAN networking environment, computing device 1001 may include a modem in communications module 1009 or other means for establishing communications over WAN 1029, such as network 1031 (e.g., public network, private network, Internet, intranet, and the like). The network connections shown are illustrative, and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP), and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smartphones, multiprocessor systems, microprocessor-based systems, set-top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, etc. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to implement one or more aspects of the disclosure more effectively, and such data structures are contemplated to be within the scope of computer-executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events described herein may be transferred between a source and a destination in light or electromagnetic waves traveling through signal-conducting media such as metal wires, optical fibers, or wireless transmission media (e.g., air or space). In general, one or more computer-readable media may be and/or include one or more non-transitory computer-readable media.

As described herein, the various methods and acts may be operative across one or more computing servers and one or more networks. The functionality may be distributed in any manner or may be located in a single computing device (e.g., a server, a client computer, and the like). For example, in alternative embodiments, one or more of the computing platforms discussed above may be combined into a single computing platform, and the single computing platform may perform the various functions of each computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A method for verifying authenticity of information in electronically distributed communications, comprising:
accessing a plurality of authenticated digital communications hosted on one or more servers and publicly accessible via an Internet;
receiving an authentication request including an unverified digital communication;
generating an authenticity score for the unverified digital communication, wherein the authenticity score indicates a degree of accuracy of information conveyed in the unverified digital communication relative to information conveyed in at least one of the plurality of authenticated digital communications; and
transmitting, in response to the authentication request, an authentication response that includes the authenticity score.

2. The method of claim 1, wherein the plurality of authenticated digital communications maintained on the one or more servers are encoded in a plurality of tamper-proof distributed ledgers.

3. The method of claim 2, further comprising:
receiving, in the authentication request, an identification of one of the plurality of authenticated digital communications; and
generating the authenticity score using the one of the plurality of authenticated digital communications as a benchmark for the authenticity score.

4. The method of claim 2, further comprising:
performing sentiment analysis of the unverified digital communication and the at least one of the plurality of authenticated digital communications, wherein the degree of accuracy is based on the sentiment analysis.

5. The method of claim 1, further comprising determining the degree of accuracy by:
extracting, using one or more artificial intelligence engines, the information conveyed in the unverified digital communication and the information conveyed in the at least one of the plurality of authenticated digital communications; and
determining a conditional probability of the information in the unverified digital communication given the information conveyed in the at least one of the plurality of authenticated digital communications.

6. The method of claim 1, further comprising:
determining entropy of the information conveyed in the unverified digital communication, wherein the entropy depends on the information conveyed in the at least one of the plurality of authenticated digital communications, and wherein the authenticity score is based on the entropy.

7. The method of claim 6, wherein determining the entropy comprises one of:
determining a conditional entropy of the information conveyed in the unverified digital communication conditioned on the information conveyed in at least one of the plurality of authenticated digital communications; and.
determining a relative entropy with respect to the information conveyed in the at least one of the plurality of authenticated digital communications.

8. The method of claim 6, wherein determining the entropy comprises:
determining a first probabilistic distribution of the information conveyed in the unverified digital communication;
determining a second probabilistic distribution of the information conveyed in the at least one of the plurality of authenticated digital communications; and
determining a relative entropy based on a difference between the first probabilistic distribution and the second probabilistic distribution.

9. The method of claim 1, further comprising:
identifying a first subset of time intervals within the at least one of the plurality of authenticated digital communications;
identifying a second subset of time intervals within the at least one of the plurality of authenticated digital communications;
detecting a first entropy of the information conveyed in the unverified digital communication based on the first subset of the time intervals;
detecting a second entropy of the information conveyed in the unverified digital communication based on the second subset of the time intervals; and
determining, based on the second entropy being greater than the first entropy, that the unverified digital communication is an altered version of the at least one of the plurality of authenticated digital communications.

10. A computing platform for safeguarding authenticity of electronically distributed public communications, the computing platform comprising:
at least one processor;
a communication interface communicatively coupled to the at least one processor and a memory having computer-readable instructions stored therein, when executed by the at least one processor, cause the computing platform to:
access a plurality of authenticated digital communications hosted on one or more servers and publicly accessible via an Internet;
receive, via the communication interface, an authentication request including an unverified digital communication;
generate an authenticity score for the unverified digital communication, wherein the authenticity score indicates a degree of accuracy of information conveyed in the unverified digital communication relative to information conveyed in at least one of the plurality of authenticated digital communications; and
transmit, via the communication interface, in response to the authentication request, an authentication response that includes the authenticity score.

11. The computing platform of claim 10, wherein the plurality of authenticated digital communications maintained on the one or more servers are encoded in a plurality of tamper-proof distributed ledgers.

12. The computing platform of claim 11, wherein the computer-readable instructions, when executed by the at least one processor, cause the computing platform to:
receive, in the authentication request, an identification of one of the plurality of authenticated digital communications; and
generate the authenticity score using the one of the plurality of authenticated digital communications as a benchmark for the authenticity score.

13. The computing platform of claim 18, wherein the computer-readable instructions, when executed by the at least one processor, cause the computing platform to:
perform sentiment analysis of the unverified digital communication and the at least one of the plurality of authenticated digital communications, wherein the degree of accuracy is based on the sentiment analysis.

14. The computing platform of claim 10, wherein the computer-readable instructions, when executed by the at least one processor, cause the computing platform to determine the degree of accuracy by:
extract, using one or more artificial intelligence engines, the information conveyed in the unverified digital communication and the information conveyed in the at least one of the plurality of authenticated digital communications; and
determine a conditional probability of the information in the unverified digital communication given the information conveyed in the at least one of the plurality of authenticated digital communications, wherein the degree of accuracy is based on the conditional probability.

15. The computing platform of claim 10, wherein the computer-readable instructions, when executed by the at least one processor, cause the computing platform to:
determine entropy of the information conveyed in the unverified digital communication, wherein the entropy depends on the information conveyed in the at least one of the plurality of authenticated digital communications, and wherein the authenticity score is based on the entropy.

16. The computing platform of claim 15, wherein, to determine the entropy, the computer-readable instructions, when executed by the at least one processor, cause the computing platform to:
determine a conditional entropy of the information conveyed in the unverified digital communication conditioned on the information conveyed in the at least one of the plurality of authenticated digital communications; or.
determine a relative entropy with respect to the information conveyed in the at least one of the plurality of authenticated digital communications.

17. The computing platform of claim 10, wherein to determine the entropy, the computer-readable instructions, when executed by the at least one processor, cause the computing platform to:
determine a first probabilistic distribution of the information conveyed in the unverified digital communication;
determine a second probabilistic distribution of the information conveyed in the at least one of the plurality of authenticated digital communications; and
determine a relative entropy based on a difference between the first probabilistic distribution and the second probabilistic distribution.

18. The computing platform of claim 10, wherein the computer-readable instructions, when executed by the at least one processor, cause the computing platform to:
identify a first subset of time intervals within the at least one of the plurality of authenticated digital communications;
identify a second subset of time intervals within the at least one of the plurality of authenticated digital communications;
detect a first entropy of the information conveyed in the unverified digital communication based on the first subset of the time intervals;
detect a second entropy of the information conveyed in the unverified digital communication based on the second subset of the time intervals; and
determine, based on the second entropy being greater than the first entropy, that the unverified digital communication is an altered version of the at least one of the plurality of authenticated digital communications.

19. One or more non-transitory computer-readable media having instructions stored therein, when executed by a computing platform comprising at least one processor, memory, and a communication interface, cause the computing platform to:
access a plurality of authenticated digital communications encoded in a plurality of tamper-proof distributed ledgers that are hosted on one or more servers and publicly accessible via an Internet;
receive, via the communication interface, an authentication request including an unverified digital communication;
extract, using one or more artificial intelligence engines, information conveyed in the unverified digital communication and information conveyed in the at least one of the plurality of authenticated digital communications
generate an authenticity score for the unverified digital communication, wherein the authenticity score indicates a degree of accuracy of the information conveyed in the unverified digital communication relative to the information conveyed in at least one of the plurality of authenticated digital communications; and
transmit, via the communication interface, in response to the authentication request, an authentication response that includes the authenticity score.

20. The one or more non-transitory computer-readable media of claim 19, wherein the instructions, when executed by the computing platform, cause the computing platform to:
determine entropy of the information conveyed in the unverified digital communication, wherein the entropy depends on the information conveyed in the at least one of the plurality of authenticated digital communications, and wherein the authenticity score is based on the entropy.
